(19) United States
(12) Patent Application Publication
(10) Pub. No.: US 2016/0186730 A1
(43) Pub. Date: Jun. 30, 2016

(54) IMPACT ACTUATOR, TOUCH PANEL, AND DRIVE METHOD

(71) Applicant: SMK Corporation, Tokyo (JP)

(72) Inventors: Yoshinori WATANABE, Kanagawa (JP); Takeshi MATSUDA, Kanagawa (JP); Yuki AKITA, Kanagawa (JP); Katsuhito FUJII, Tokyo (JP)

(21) Appl. No.: 14/970,546

(22) Filed: Dec. 16, 2015

Related U.S. Application Data
(63) Continuation of application No. PCT/JP2015/061649, filed on Apr. 9, 2015.

(30) Foreign Application Priority Data
Dec. 25, 2014 (JP) 2014-262043

(51) Int. Cl. F03G 7/06; G06F 3/041; G06F 3/01

(52) U.S. Cl. CPC F03G 7/065; G06F 3/016; G06F 3/0416

(57) ABSTRACT

Various operation feelings are provided in, for example, an impact actuator. The impact actuator includes a drive signal output unit for outputting a drive signal in which the voltage of a single pulse signal is changed with time, and a shape memory alloy through which an electric current is caused to pass in a period corresponding to the drive signal.

### CROSS REFERENCE TO RELATED APPLICATION

The contents of the following Japanese patent application and International patent application are incorporated herein by reference,

Japanese Patent Application No. 2014-262043 filed on Dec. 25, 2014, and

International Patent Application No. PCT/JP2015/061649 filed on Apr. 9, 2015.

### FIELD

The present invention relates to an impact actuator, a touch panel, and a drive method, and more specifically relates to, for example, an impact actuator, a touch panel, and a drive method that use a shape memory alloy the shape of which changes by causing an electric current to pass therethrough.

### BACKGROUND

Conventionally, there are known actuators using a shape memory alloy (hereinafter abbreviated by SMA as appropriate), which expands and shrinks depending on a change in temperature. For example, the following Patent Literature 1 describes an actuator that produces vibration of various magnitudes by changing the voltage (peak value) of a pulse signal to be applied to the actuator.

### CITATION LIST

### Patent Literature

Patent Literature 1: Japanese Patent Application Laid-Open No. 2008-262478

### SUMMARY

### Technical Problem

In the actuator described in Patent Literature 1, since the peak value is invariant in the single pulse signal, it is difficult to produce various operation feelings in accordance with the single pulse signal.

Thus, one of objects of the present invention is to provide a novel and useful impact actuator, touch panel, and drive method that can solve the above-described problem.

### Solution to Problem

To solve the above problem, a first aspect of the present invention is, for example, an impact actuator that includes a drive signal output unit for outputting a drive signal in which a voltage of a single pulse signal is changed with time, and a shape memory alloy through which an electric current is caused to pass in a period corresponding to the drive signal.

A second aspect of the present invention is, for example, a touch panel that includes an input unit on which an input operation is performed, a drive signal output unit for outputting a drive signal in which a voltage of a single pulse signal is changed with time in response to the input operation, and a shape memory alloy through which an electric current is caused to pass in a period corresponding to the drive signal.

A third aspect of the present invention is, for example, a drive method of an impact actuator, the method including the steps of: outputting a drive signal in which a voltage of a single pulse signal is changed with time; and causing an electric current to pass through a shape memory alloy in a period corresponding to the drive signal.

According to at least one of embodiments, various operation feelings can be produced.

### BRIEF DESCRIPTION OF DRAWINGS

FIG. 1 is a diagram for explaining the circuitry of a common actuator.

FIG. 2 is a waveform chart for explaining a drive signal in the common actuator.

FIG. 3 is a drawing for explaining an example of a measurement method of an acceleration.

FIG. 4 is a drawing for explaining an example of the structure of an actuator in embodiments of the present invention.

FIG. 5A is a drawing for explaining an example of operation of the actuator in the embodiments of the present invention.

FIG. 5B is a drawing for explaining an example of operation of the actuator in the embodiments of the present invention.

FIG. 6 is a diagram for explaining the circuitry of an actuator in a first embodiment.

FIG. 7 is a waveform chart for explaining a drive signal of the actuator in the first embodiment.

FIG. 8 is a diagram for explaining the circuitry of an actuator in a second embodiment.

FIG. 9 is a graph for explaining an example of the characteristics of a MOSFET.

FIG. 10 is a waveform chart for explaining a drive signal of the actuator in the second embodiment.

FIG. 11 is a graph for explaining variation in the drive signal with time, variation in an electric current passing through a SMA with time, and variation in an acceleration of the actuator with time in the second embodiment.

FIG. 12A is a graph for explaining a modification example of the drive signal.

FIG. 12B is a graph for explaining a modification example of the drive signal.

FIG. 12C is a graph for explaining a modification example of the drive signal.

FIG. 12D is a graph for explaining a modification example of the drive signal.

### DESCRIPTION OF EMBODIMENTS

Embodiments of the present invention will be described below with reference to the drawings. The description is given in the following sequence.

### 1. First Embodiment

### 2. Second Embodiment

### 3. Modification Examples

The embodiments and the like described below are preferable concrete examples of the present invention, and do not limit the contents of the present invention. Moreover, effects described below are just examples, and do not limit the interpretation of the contents of the present invention.

### [Structure of Common Actuator]

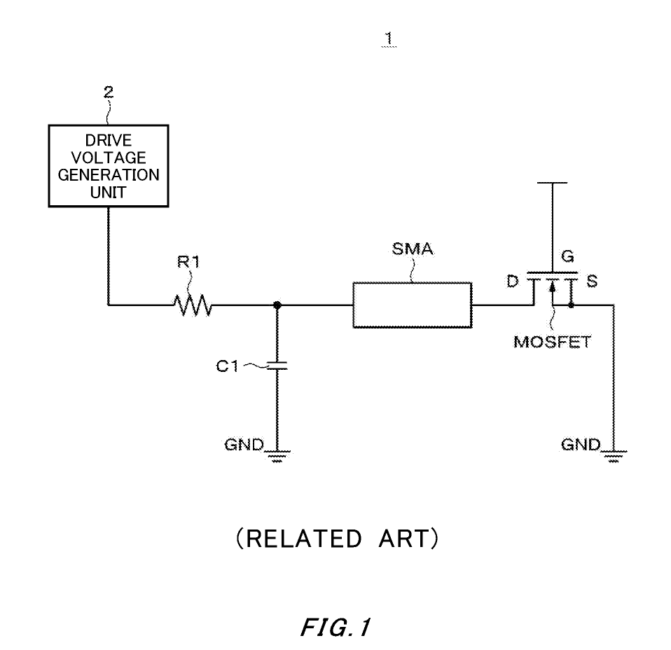

First, the structure of a common impact actuator (hereinafter appropriately abbreviated as actuator) will be described for the purpose of ease of understanding of the present invention. In the following description, a structure including a SMA, a drive circuit for switching the SMA between an energized state and a non-energized state, and the like is collectively called an actuator. FIG. 1 shows an example of the structure of the common actuator (actuator 1). A drive voltage is input from a drive voltage generation unit 2 to the actuator 1. To the drive voltage generation unit 2, one end of a resistor R1 is connected. The SMA is connected to the other end of the resistor R1. A capacitor C1 one end of which is grounded (GND) is connected to a node between the resistor R1 and the SMA. The capacitor C1 is charged by the drive voltage generated by the drive voltage generation unit 2.

A switching element is connected in series to the SMA. The switching element is, for example, an N-channel type MOSFET (metal oxide field effect transistor). The drain (D) of the MOSFET is connected to the SMA. The source (S) of the MOSFET is grounded. To the gate (G) of the MOSFET, a single pulse signal is input to control the switching operation of the MOSFET.

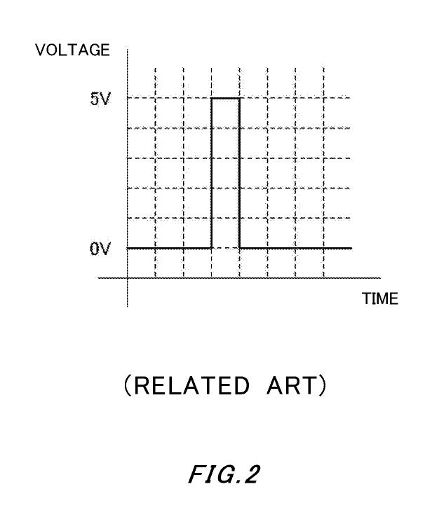

FIG. 2 shows an example of the single pulse signal. The single pulse signal is, for example, a pulse signal to be generated and output in response to an input operation by a user. The high level of the single pulse signal is, for example, 5 V (volts), while the low level thereof is 0 V. As a matter of course, each level is set at any corresponding voltage in accordance with the characteristics of the MOSFET. In the single pulse signal, the voltage is kept constant at the high level. The MOSFET is turned on when the single pulse signal is at the high level, while the MOSFET is turned off when the single pulse signal is at the low level.

By performing ON/OFF control of the MOSFET, the SMA is switched between the energized state and the non-energized state. For example, while the MOSFET is turned on, the capacitor C1 is discharged, and thereby the SMA is heated by causing an electric current to pass therethrough. The heating by the passage of the electric current shrinks the SMA at a predetermined acceleration. While the MOSFET is turned off, the passage of the electric current through the SMA is stopped, and thereby the SMA expands by cooling with outside air. The shrinkage of the SMA actuates the actuator. The actuation of the actuator can provide an intended operation feeling to the user who has performed the input operation.

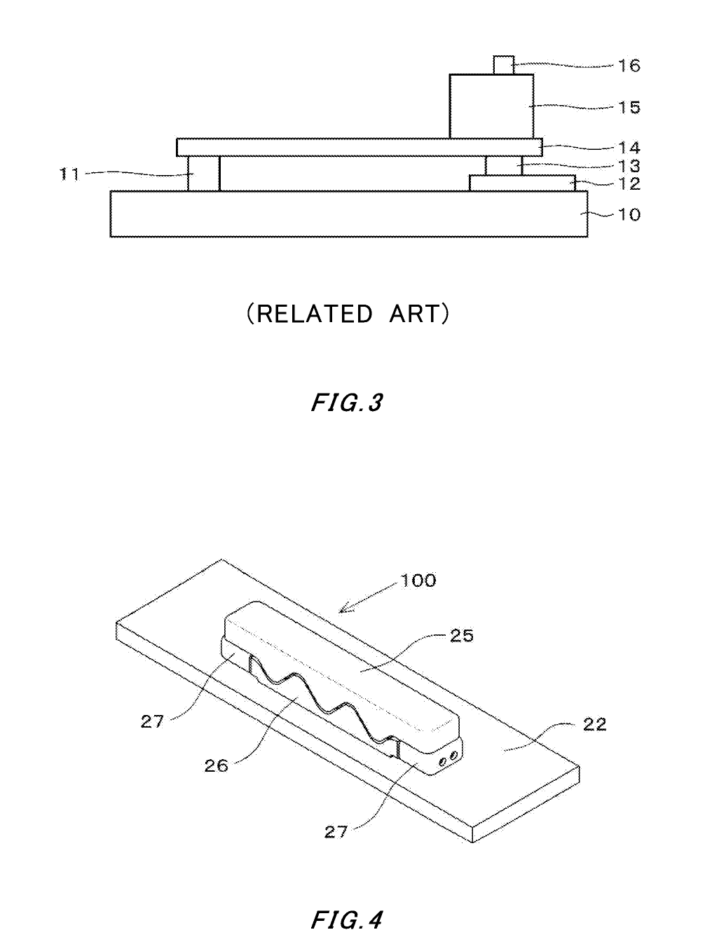

FIG. 3 is the drawing for explaining an example of a measurement method of the acceleration of the actuator. Note that, equipment (for example, a touch panel) to which the actuator is applied is taken into consideration in the following exemplified measurement method of the acceleration, but the measurement method of the acceleration is not limited to the method exemplified below. The characteristics of the actuator may be defined by another parameter.

As illustrated in FIG. 3, a brass plate 10 is put on a flat surface. The thickness of the brass plate 10 is set at, for example, 30 mm (millimeters). A rubber foot 11 is attached on the top surface of the brass plate 10. A PWB (printed wiring board) 12 is also attached on the top surface of the brass plate 10, and an actuator 13 is mounted on the PWB 12. The thickness of the rubber foot 11 is made the same or substantially the same as the total thickness of the PWB 12 and the actuator 13, so that the rubber foot 11, the actuator 13, and the like support end portions of a touch panel 14. The thickness of the touch panel 14 is set at, for example, 0.7 mm.

A weight 15 is put on the touch panel 14, and an acceleration sensor 16 is attached on the weight 15. The weight 15 is, for example, 100 g (grams). As the acceleration sensor 16, a well-known sensor can be used. The weight 15 and the acceleration sensor 16 are disposed such that the center lines of the actuator 13, the weight 15, and the acceleration sensor 16 coincide or substantially coincide with each other. The acceleration is measured with such an acceleration measurement jig having the structure described above. More specifically, applying the single pulse signal described below heats the SMA of the actuator 13 by causing the electric current to pass therethrough, and the acceleration sensor 16 measures the acceleration caused by the expansion and shrinkage of the SMA.

In the common actuator, as described above, the SMA can be heated quickly by turning on the MOSFET by the single pulse signal. Thus, the actuator using the SMA has the advantage of increased responsiveness owing to the quick shrinkage of the SMA. In the case of applying the actuator to a touch panel, the touch panel has the advantage of being able to provide a certain vibration or impact (also called click feeling) to a fingertip of a user who has touched an input panel of the touch panel, due to the operation of the actuator. On the other hand, since the voltage of the single pulse signal is invariant with time, there is a problem that various operation feelings are difficult to provide by the operation of the actuator. There is also a problem that an operation sound of the actuator might be more dominant than the feeling that the actuator provides to a fingertip of a user. The embodiments of the present invention, which is made in consideration of above, will be described.

### 1. First Embodiment

### Form of Actuator

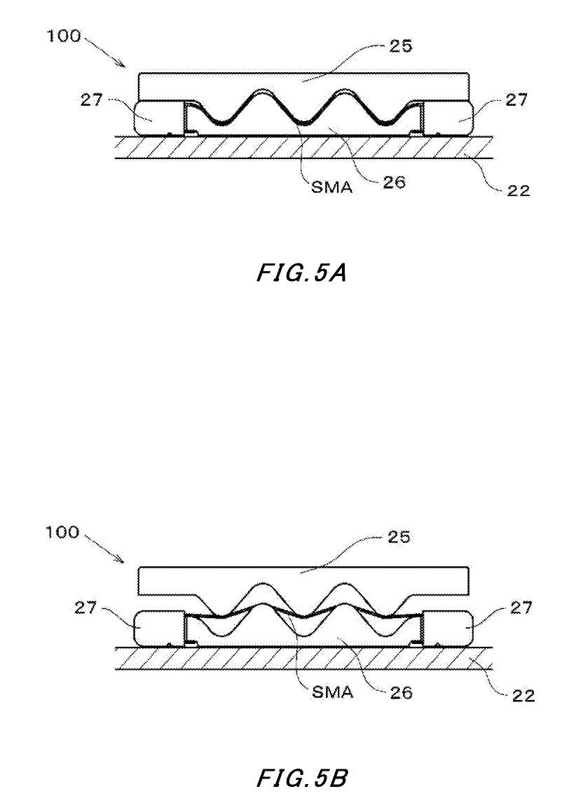

Next, the form of an actuator in the first embodiment of the present invention will be described with reference to FIGS. 4, 5A and 5B. It is noted that the form of the actuator described below is applicable to the second embodiment and the modification examples. The form of the actuator according to the present invention is not limited to the form described below.

FIG. 4 shows the external appearance of an actuator 100. The drawing shows an initial state of the actuator 100 before a displacement occurs. The actuator 100 is formed on a top surface of a printed wiring board 22.

The actuator 100 includes, for example, a movable member 25, a fixed member 26, two terminal fittings 27, and the SMA in the shape of, for example, a string. Both of the movable member 25 and the fixed member 26 are made of an insulating rigid material. A bottom surface of the movable member 25 and a top surface of the fixed member 26 are formed in the shape of convex and concave waves fitted with each other, and the SMA is disposed between the convex and concave surfaces of the both members. Note that, the movable member 25 and the fixed member 26 may be made of a conductive metal material or the like, but in this case, a structure is necessary to prevent shorts between the two terminal fittings 27, such as insulating films provided on the surfaces of the movable member 25 and the fixed member 26, respectively.

The SMA is secured to both ends of the fixed member 26 by the terminal fittings 27. The SMA in this embodiment is made of, for example, a nickel-titanium alloy that has conductivity, predetermined resistance, and the shape of a flexible string with an extremely narrow diameter in an environment around the room temperature. Passing the electric current through the SMA generates heat by the SMA itself, and the heat hardens and shrinks the SMA. It is noted that the SMA is not limited to the nickel-titanium alloy, but may be another metal or alloy as long as it has similar characteristics.

The terminal fittings 27 are fitted onto the respective ends of the fixed member 26 together with ends of the SMA, so as to secure the ends of the SMA with sufficient strength to prevent the SMA from loosening. The terminal fittings 27 are made of a conductive metal, and soldered to a land (not shown) in a predetermined shape provided on the printed wiring board 22. Thus, the fixed member 26 is secured on the printed wiring board 22.

The formative operation of the actuator 100 will be described with reference to FIGS. 5A and 5B. FIG. 5A shows a state in which no electric current is caused to pass through the SMA, in other words, a state before the displacement occurs. In this state, the SMA is soft and flexible. In this state, the movable member 25 and the fixed member 26 are in close proximity to each other by, for example, an attraction force of a not-shown magnet, while catching the SMA therebetween.

FIG. 5B shows a state in which the electric current is caused to pass through the SMA, in other words, a state after the displacement occurs in the actuator 100. The SMA shrinks in this state, and in conjunction with this, the movable member 25 is vertically displaced in a direction away from the fixed member 26 against the attraction force of the magnet. When a cover member (not illustrated in the drawing) is put on the movable member 25, the cover member is displaced together in the same direction.

When the electric current stops flowing through the SMA, from the state illustrated in FIG. 5B, the SMA returns to a non-energized state length by being cooled due to a temperature difference from the atmosphere and heat dissipation to the movable member 25, the fixed member 26, and the terminal fittings 27, and therefore quickly returns to the state illustrated in FIG. 5A by the action of the attraction force of the magnet.

Note that, the following description describes an example in which the actuator is applied as a vibration device of the touch panel. For example, the input panel is formed on the movable member 25 of the actuator 100, to perform various input operations thereon. Upon detecting the input operation, the single pulse signal (drive signal) having a voltage (high level voltage) changing with time is generated and output. As described later in detail, in a period corresponding to the single pulse signal, the SMA is heated and shrinks by the passage of the electric current therethrough. Using the drive signal that is different from a drive signal used in the common actuator allows the provision of the various operation feelings.

### [Drive Circuit]

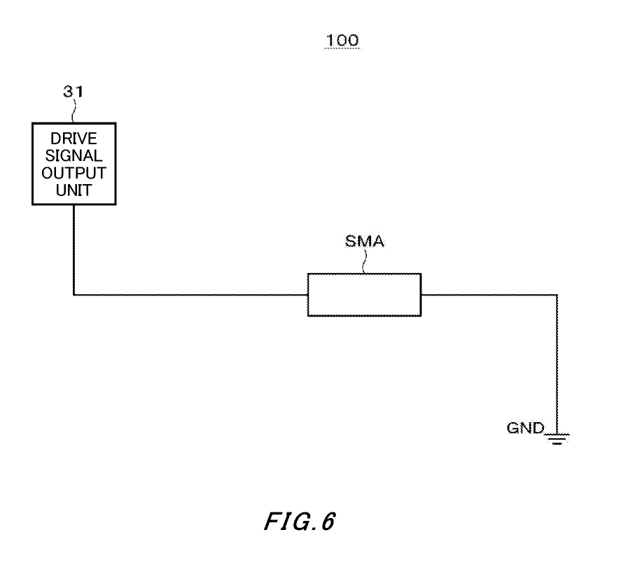

FIG. 6 shows an example of a drive circuit in the actuator 100 in the first embodiment. The actuator 100 is provided with a drive signal output unit 31 and the SMA, which is connected between the drive signal output unit 31 and a ground (GND). The drive signal output unit 31 generates and outputs the single pulse signal, being the drive signal. The drive signal output unit 31 is constituted by, for example, a microcomputer, and generates and outputs the single pulse signal in response to the input operation on the touch panel. The single pulse signal output from the drive signal output unit 31 is supplied to the SMA, so that the SMA is heated by the passage of the electric current in the period corresponding to the single pulse signal. In other words, the single pulse signal is directly applied to the SMA in the first embodiment.

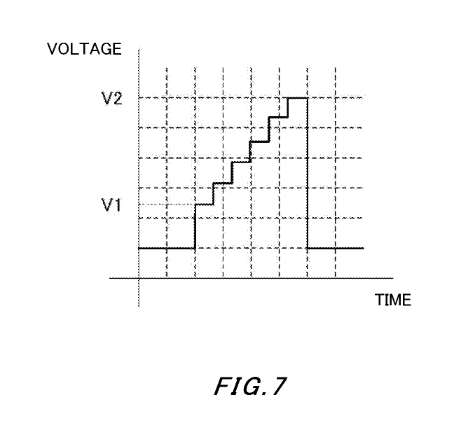

FIG. 7 shows an example of the single pulse signal in the first embodiment. As illustrated in FIG. 7, the drive signal is a signal in which the voltage of the single pulse signal is changed with time. To be more specific, the single pulse signal is a signal in which the voltage is increased with time between a voltage V1 and a voltage V2 (V1<V2). The voltage V1 and the voltage V2 are appropriately settable in accordance with the characteristics and the like of the SMA to be heated, and the voltage V1 may be 0 V. The electric current flowing through the SMA can be controlled by the voltage. It is noted that the voltage of the single pulse signal is changed stepwise in FIG. 7, and the height of the steps (the degree of change in the voltage), the width of the steps (period), and the like are settable appropriately. The waveform of the single pulse signal is not limited to that illustrated in FIG. 7, as long as the voltage of the single pulse signal is changed with time.

### [Operation of Actuator]

An example of the operation of the actuator 100 will be described. Upon the input operation on the touch panel (for example, a touch of the input panel), the input operation is detected by a not-shown detector. The detector informs the drive signal output unit 31 that the input operation has been performed. In response to the performance of the input operation, the drive signal output unit 31 generates and outputs the single pulse signal, as illustrated in FIG. 7. The single pulse signal output from the drive signal output unit 31 is applied to the SMA, so that the SMA is heated by the passage of the electric current.

Since the voltage of the single pulse signal gradually increases, the SMA is heated gradually, instead of rapidly, by the passage of the electric current and shrinks gently. In other words, an acceleration caused by the shrinkage of the SMA can be reduced. Accordingly, the movable member 25 of the actuator 100 is lifted slowly in a vertical direction, thus providing a slow feeling of resistance to the fingertip of the user. Although the acceleration with the operation of the SMA is lower than an acceleration of the SMA in the common actuator, a longer operation time required gives a feeling of operation for long time to the fingertip of the user. Furthermore, reducing the acceleration with the operation of the SMA prevents a break and the like of the SMA, which are likely to occur when the SMA is rapidly heated and shrinks with a high acceleration. Moreover, an operation sound of the actuator can be reduced.

### 2. Second Embodiment

Next, the second embodiment will be described. As described above, the form of the actuator 100 in the first embodiment is applicable as the form of an actuator (actuator 200) in the second embodiment.

### [Drive Circuit]

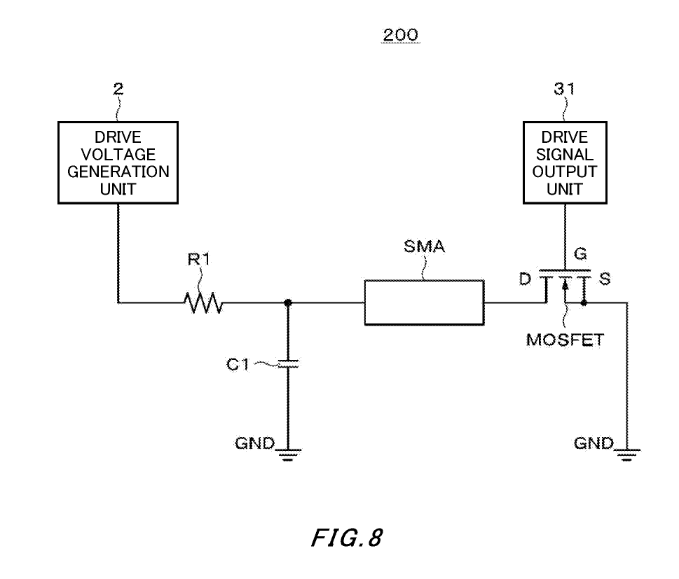

FIG. 8 is the drawing for explaining an example of a drive circuit of the actuator 200. In the second embodiment, the drive circuit of the common actuator is used almost as-is without extensive modification. Schematically speaking, the drive voltage is input from the drive voltage generation unit 2 to the actuator 200. The resistor R1, the SMA, and the N-channel type MOSFET are connected in series from the side of the drive voltage generation unit 2 between the drive voltage generation unit 2 and the ground (GND). The capacitor C1 (an example of an electric storage element) one end of which is grounded is connected to the node between the resistor R1 and the SMA. The capacitor C1 is charged by the drive voltage generated by the drive voltage generation unit 2, and discharging the capacitor C1 makes the electric current flow through the SMA and between the source and drain of the MOSFET. Note that, it is assumed that the capacitor C1 becomes charged during the operation of the actuator 200. The gate of the MOSFET is connected to the drive signal output unit 31. The single pulse signal generated by and output from the drive signal output unit 31 is input to the gate of the MOSFET.

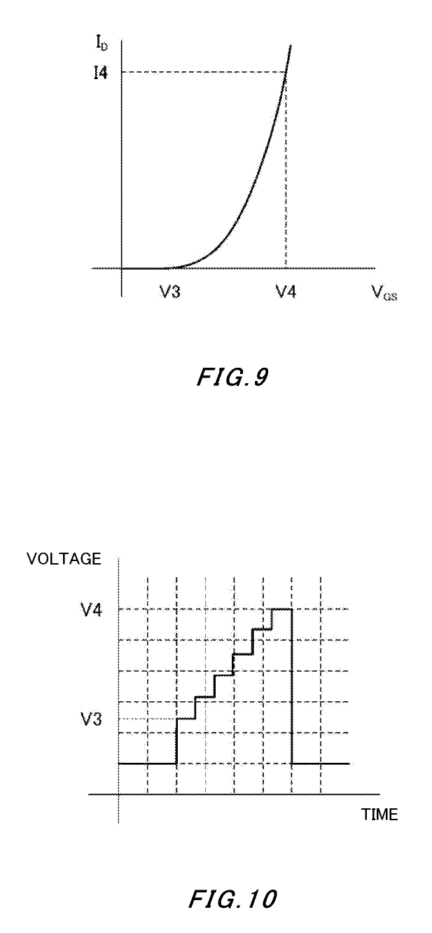

FIG. 9 is the drawing illustrating an example of the characteristics of the MOSFET. In the characteristic diagram of FIG. 9, a horizontal axis represents a voltage V_{GS} between the gate and the source, while a vertical axis represents a drain current I_{D}. As is apparent from FIG. 9, the MOSFET in the embodiment of the present invention has enhancement properties such that the drain current I_{D} increases with increase in the voltage V_{GS} to more than a predetermined value. When the voltage V_{GS} between the gate and the source is at V3, the drain current I_{D} starts flowing. That is, the voltage V3 is a voltage corresponding to a gate threshold voltage. However, since the flowing current is low, the MOSFET is in an OFF state, in terms of switching. When the voltage V_{GS} between the gate and the source is at V4 (where V3<V4), the sufficient drain current I_{D} flows, and the MOSFET is in an ON state in terms of switching. That is, the voltage V4 is a voltage corresponding to an ON voltage. The voltage V3 and the voltage V4 are appropriately set in accordance with the characteristics and the like of the MOSFET.

### [Drive Signal]

FIG. 10 shows an example of the single pulse signal in the second embodiment. The single pulse signal in the second embodiment is a signal in which the voltage of the single pulse signal is changed with time between the voltage V3 being the gate threshold voltage and the voltage V4 being the ON voltage, and more specifically is a signal in which the voltage is increased with time between the voltage V3 and the voltage V4. It is noted that a minimum value of the voltage is not necessarily the voltage V3, and a maximum value of the voltage is not necessarily the voltage V4, as long as the minimum value of the voltage and the maximum value of the voltage of the single pulse signal fall within the range of the voltage V3 to the voltage V4.

### [Operation of Actuator]

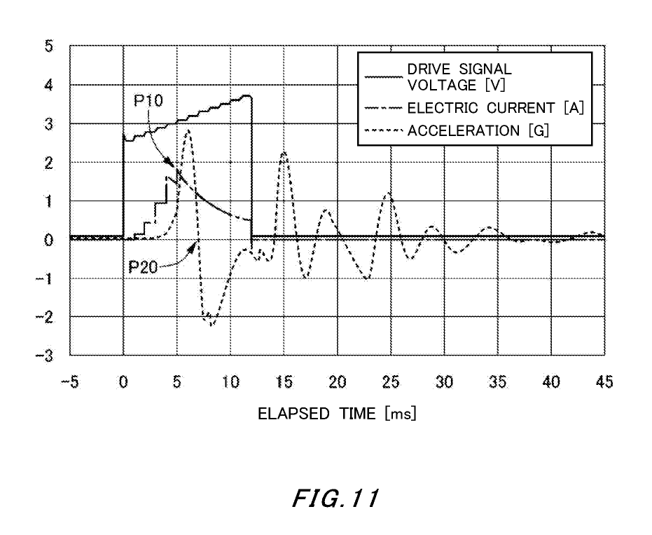

FIG. 11 is the graph that schematically shows variation in the voltage (V) of the single pulse signal with time, variation in the electric current (A) flowing through the SMA with time, and variation in the acceleration (G) of the actuator 200 with time. Note that, in the graph, a solid line represents the variation in the voltage of the single pulse signal with time, an alternate long and short dashed line represents the variation in the electric current flowing through the SMA with time, and a dotted line represents the variation in the acceleration of the actuator 200 with time. It is noted that an explanation is made on the condition that the waveform of the single pulse signal is the same as the waveform illustrated in FIG. 10.

An example of the operation of the actuator 200 will be described with reference to FIG. 11. The single pulse signal is output from the drive signal output unit 31 in response to the input operation, and the single pulse signal is input to the gate of the MOSFET. Since the voltage of the single pulse signal is higher than the voltage V3 being the gate threshold voltage, the drain current I_{D} flows between the drain and the source of the MOSFET.

The drain current I_{D} flowing between the drain and the source of the MOSFET gradually increases with increase in the voltage of the single pulse signal. In other words, since the electric current flowing through the SMA can gradually increase, the electric current flowing through the SMA can be changed with time. Thus, the SMA gradually shrinks, and the acceleration increases. The SMA is the most heated by the passage of the electric current in the vicinity of a point (a point indicated with P10 in the vicinity of 5 ms (milliseconds) in FIG. 11) at which the drain current I_{D} is maximized, in other words, the electric current flowing through the SMA is maximized. Viewing this in terms of acceleration, the acceleration increases in the course of shrinking the SMA, and the displacement stops, that is, the acceleration becomes zero when the SMA shrinks the most. A state having an acceleration of zero (a point indicated with P20 in FIG. 11) is a state in which the SMA shrinks the most.

The electric current flowing through the SMA reaches its peak in the course of increase in the voltage of the single pulse signal, and then decreases. This is because the capacity of the capacitor C1 decreases. Thereafter, the electric current flowing through the SMA decreases. In other words, energy to be applied to the SMA decreases. After the capacitor C1 is discharged and the electric current stops flowing through the SMA, the SMA extends by natural cooling by outside air and the like. As a matter of course, increase in the capacity of the capacitor C1 allows increase in the voltage of the single pulse signal, and hence increase in the electric current flowing through the SMA. After the acceleration increases once and becomes zero, the waveform of the acceleration appears. This is variation in the acceleration generated when the movable member 25 returns to the initial position, that is, the acceleration generated by vibration caused by a restoring force and the like occurring around the acceleration sensor, after the SMA shrinks.

As described above, according to the actuator 200, it is possible to control the energy to be applied on a time basis within the single heat shrinkage of the SMA, and control a heating time of the SMA in an arbitrary manner. Thus, the SMA can be shrunk gently or at a shrinkage rate increasing stepwise. By applying the actuator 200 to a vibration driver of a touch panel, it is possible to give a slow operation feeling to a fingertip because the actuator 200 operates gently. To give a strong impact, the same single pulse signal as that of the common actuator is input to the MOSFET. A combination of the above allows providing various operation feelings. In addition, the same effects as the first embodiment, that is, the reduction of the operation sound and the like can be obtained. Furthermore, the actuator of the second embodiment has the same circuit structure as the common actuator, thus eliminating the need for modifying the circuit structure and having a cost advantage.

### 3. Modification Examples

The embodiment of the present invention is described above in detail. However, the present invention is not limited to the above embodiments but can be variously modified. The modification examples will be described below. It is noted that the matters described in the embodiments can be applicable to the modification examples unless otherwise specified.

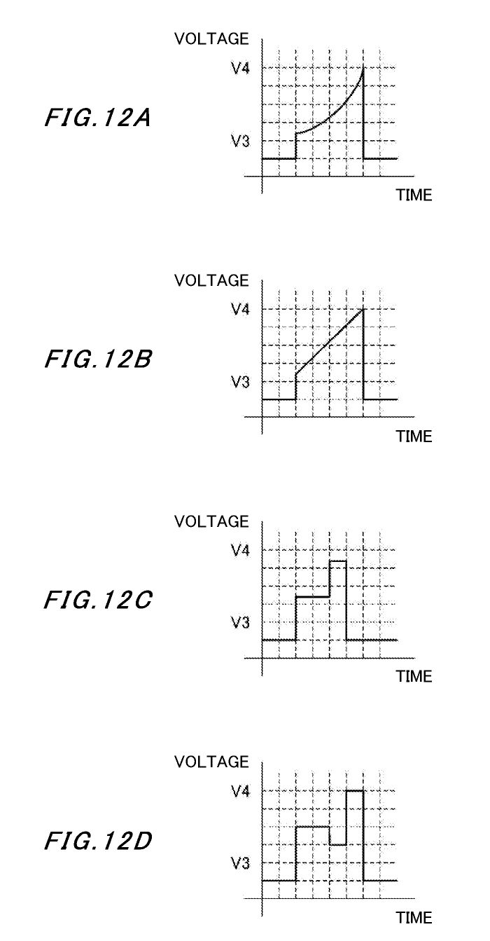

FIGS. 12A to 12D are the graphs illustrating waveforms of the single pulse signal in the modification examples. FIG. 12A shows the single pulse signal in which the voltage is exponentially increased within the range from the voltage V3 to the voltage V4. FIG. 12B shows the single pulse signal in which the voltage is linearly increased within the range from the voltage V3 to the voltage V4. FIG. 12C shows the single pulse signal in which a higher voltage than the voltage V3 is first applied and then a voltage higher than the first applied voltage and lower than the voltage V4 is applied in such a manner that the application of the voltages is switched in a stepwise manner. The waveform of the single pulse signal is appropriately changeable like this. It is noted that, as illustrated in FIG. 12D, the voltage may be temporarily decreased, instead of just increasing with time. The voltage may be made temporarily lower than the voltage V3, being the gate threshold voltage, so as to temporarily prevent the electric current from flowing through the SMA.

In the above embodiments, both of the detector for detecting the input operation and the drive signal output unit may be constituted by the same structure such as the microcomputer. The drive circuit in the above embodiment uses the capacitor C1, but may be a circuit without any capacitor in which the SMA and the like are connected directly to the drive voltage generation unit 2. The capacitor C1 may be an electric double layer capacitor, a secondary battery, or the like. The switching element is not limited to the N-channel type MOSFET, but may be a P-channel type MOSFET or another switching element. The circuit structure and the like are appropriately changeable in accordance with the switching element to be used.

The structures, methods, processes, forms, materials, numerical values, and the like described in the above-described embodiments and modification examples are just examples, and different structures, methods, processes, forms, materials, numerical values and the like from those described are usable as necessary. The structures, methods, processes, forms, materials, numerical values, and the like described in the above embodiments and modification examples can be combined with each other so long as a technical contradiction does not arise. Moreover, the present invention can be realized as, for example, a method, a program, and a recording medium having the program stored therein, instead of apparatus.

### REFERENCE SIGNS LIST

drive signal output unit
100, 200 actuator
SMA shape memory alloy
MOSFET switching element
C1 capacitor

1. An impact actuator comprising:
a drive signal output unit for outputting a drive signal in which a voltage of a single pulse signal is changed with time; and
a shape memory alloy through which an electric current is caused to pass in a period corresponding to the drive signal.

2. The impact actuator according to claim 1, wherein the drive signal is directly applied to the shape memory alloy.

3. The impact actuator according to claim 1, comprising a switching element connected in series to the shape memory alloy, and
wherein the drive signal output unit changes the electric current flowing through the shape memory alloy with time by outputting the drive signal to the switching element.

4. The impact actuator according to claim 3, wherein the drive signal output unit changes a voltage with time between a first voltage at which the electric current flows through the switching element and a second voltage which is higher than the first voltage and at which the switching element is turned on.

5. The impact actuator according to claim 3, comprising:
a drive voltage generation unit; and
an electric storage element being charged by a drive voltage generated by the drive voltage generation unit, and
wherein the drive signal is supplied to the switching element, when the electric storage element is in a charged state.

6. The impact actuator according to claim 3, wherein the switching element comprises a MOSFET.

7. The impact actuator according to claim 1, wherein the drive signal output unit outputs the drive signal in response to a predetermined input operation.

8. A touch panel comprising:
an input unit on which an input operation is performed;
a drive signal output unit for outputting a drive signal in which a voltage of a single pulse signal is changed with time in response to the input operation; and
a shape memory alloy through which an electric current is caused to pass in a period corresponding to the drive signal.

9. A drive method of an impact actuator, the method comprising the steps of:
outputting a drive signal in which a voltage of a single pulse signal is changed with time; and
causing an electric current to pass through a shape memory alloy in a period corresponding to the drive signal.
